(19) United States
(12) Patent Application Publication
(10) Pub. No.: US 2005/0078995 A1
(43) Pub. Date: Apr. 14, 2005

(54) Label printer

(76) Inventors: Mario Van Bever, Evergem (BE); Jos Vleurinck, Oordegem (BE)

Correspondence Address: MORGAN LEWIS & BOCKIUS LLP, 1111 PENNSYLVANIA AVENUE NW, WASHINGTON, DC, 20004, US

(21) Appl. No.: 10/499,699

(22) PCT Filed: Dec. 23, 2002
(86) PCT No.: PCT/IB02/05803

(30) Foreign Application Priority Data
Dec. 21, 2001 (GB) 0130690.1

(51) Int. Cl. B41J 5/30

(52) U.S. Cl. 400/62

(57) ABSTRACT

This present invention relates to a label printer having receiving means which is arranged to receive a removable memory, said removable memory comprising information for a plurality of labels, said information comprising date to be printed by said label printer and information relating to said label, and means for retrieving said information from said removable memory when present.

The present invention relates to a label printer. In particular, but not exclusively, the present invention relates to a tape on which labels can be printed.

Tape printers of the general type with which some embodiments of the present invention are concerned are disclosed for example in EP-A-322918 and EP-A-322919 (Brother Kyogo Kabushiki Kaisha) and EP-A-0267890 (Varitronic). These printers each include a printing device having a cassette receiving bay for receiving a cassette or tape holding case. In EP-A-0267890, the tape cassette has an ink ribbon and a substrate tape, the substrate tape comprising an upper image receiving layer secured to a backing layer by adhesive. In EP-A-322918 and EP-A-322919, a tape cassette houses an ink ribbon, a transparent image receiving tape and a double sided adhesive tape, which is secured at one of its adhesive coated sides to the image tape after printing and which has a backing layer peelable from its other adhesive coated side. The image is printed on the side of the image receiving tape, which is adhered to the adhesive coated tape. Thus, the printed image is covered by a protective layer. In both of these tape printers, the image transfer medium (ink ribbon) and the image receiving tape (substrate) are in the same cassette.

The present applicants have developed a different type of tape printer, which is described in, for example, European Patent Application No 578372. In this printer, the substrate tape has a structure similar to that described in EP-A-267890 but is housed in its own cassette while the ink ribbon is similarly housed in its own cassette.

In all of these cases, the image receiving tape passes in overlap with the ink ribbon through a print zone consisting of a fixed print head and a platen against which the print head can be pressed to cause an image to transfer from the ink ribbon to the image receiving tape. There are many different ways of doing this, including dry lettering or dry film impression. The most usual way at present is by thermal printing. With thermal printing, the print head is heated and the heat causes ink from the ink ribbon to be transferred to the image receiving tape. It should be appreciated that it is also known to apply an image directly using a thermal print head to thermally sensitive image receiving tape.

Label printers which print on discrete labels are also known. Those discrete labels may be applied to a backing layer via an adhesive layer.

Currently, when a user wishes to print a label, it is necessary for the user to input that label. Label printers can be computer connected where data is passed directly from the computer to the tape printer. This may be done by the keyboard of the PC. Alternatively the tape printer may be independent where the labels are created on a keyboard of the label printer. With these independent or stand alone tape printers, limited memory of designed labels is sometimes included where the detail is stored in memory within the printers. However, these independent label printers are generally cost constrained and accordingly tend to have limited memory and processing power leading to more limited functionality. Additionally the keyboards can be small and/or formatted so data entry is relatively slow. If the user is on a site where a number of items need to be labelled, it can be time consuming to enter the required labels and to print them. This can be a particular problem where the access time to the site is limited. It is of course possible that the labels be printed out in advance. However, care then needs to be taken with the storage of those labels. Additionally, if there are a large number of labels, then it can take some time to select the correct label.

Whilst label printers which are used with PCs have more memory and more functionality, they are not portable in that the require a PC in order to operate properly.

It is therefore an aim of embodiments of the present invention to at least address the above described problem.

According to a first aspect of the present invention, there is provided a label printer having receiving means which is use is arranged to receive a removable memory.

Preferred embodiments of the invention provide a low cost solution for transferring data from a computer to a portable printer. The data is stored in the label printer and may be used later, at which time it can be edited if the user so wishes. Embodiments of the invention may use a low cost SIM card type solution, as found in mobile phones, for data storage. Using, for example, ASCII code to store data enables large amount on data label to be stored in a restricted capacity memory device.

For a better understanding of the present invention and as to how the same may be carried into effect, reference will now be made by way of example only to the accompanying drawings in which:

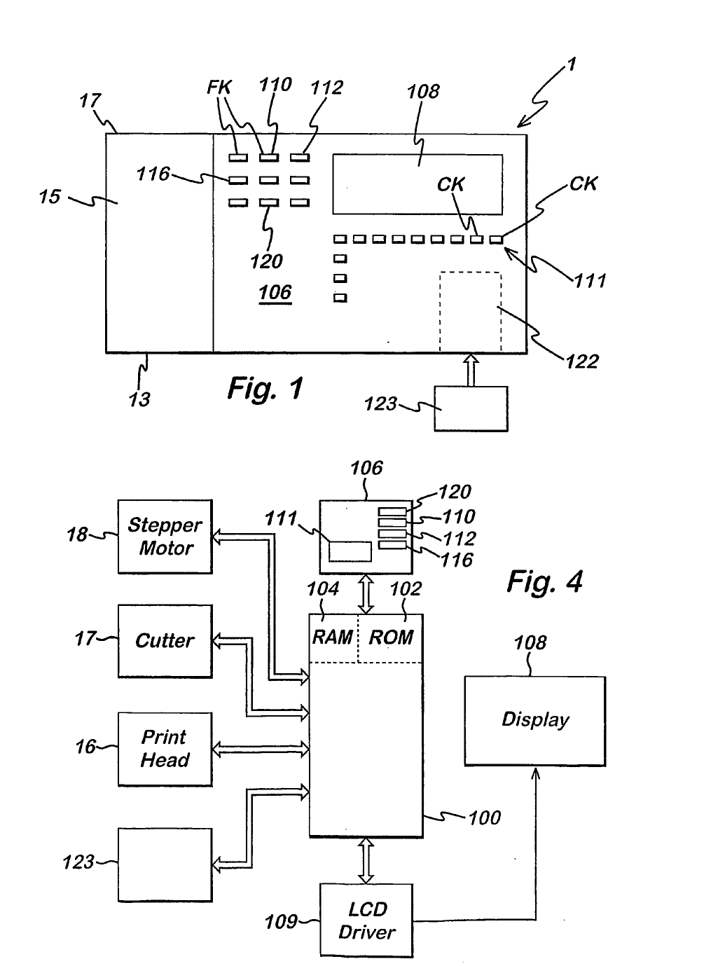

FIG. 1 shows a plan view of the top surface of a standalone printing device;

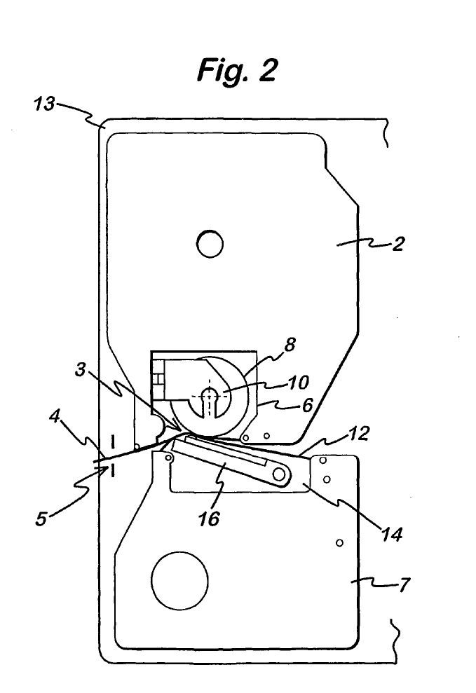

FIG. 2 is a plan view showing two cassettes inserted in the printing device of FIG. 1;

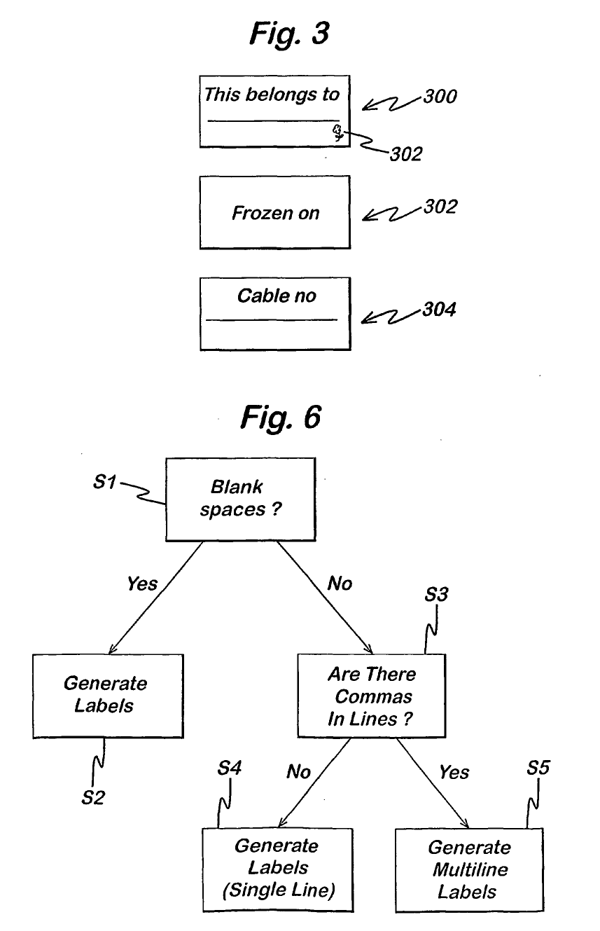

FIG. 3 shows some sample labels;

FIG. 4 is a diagrammatic sketch showing the control circuitry for the tape printer of FIG. 1;

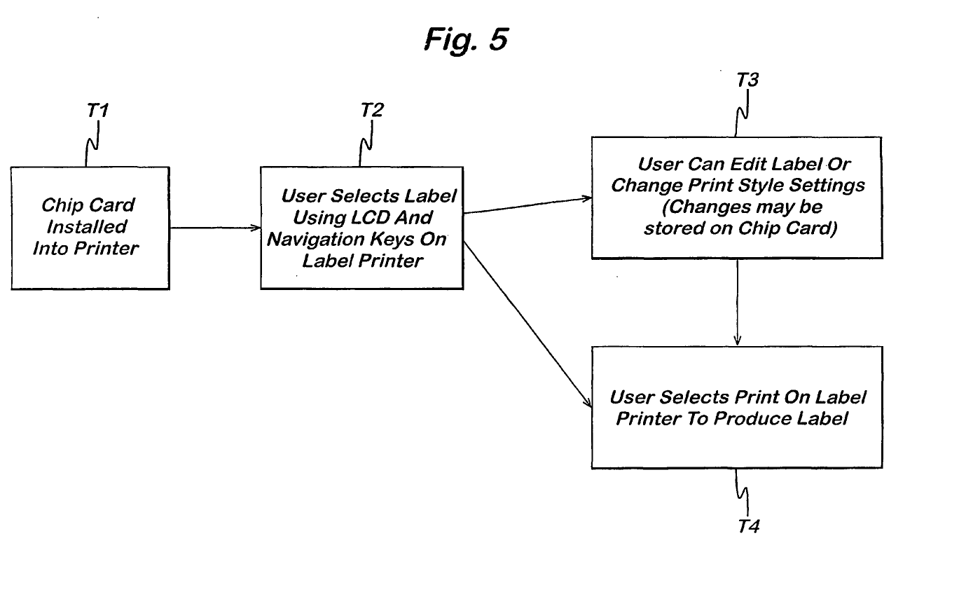

FIG. 5 shows a flow diagram of a method embodying the invention;

FIG. 6 is a flow diagram illustrating a further method embodying the present invention;

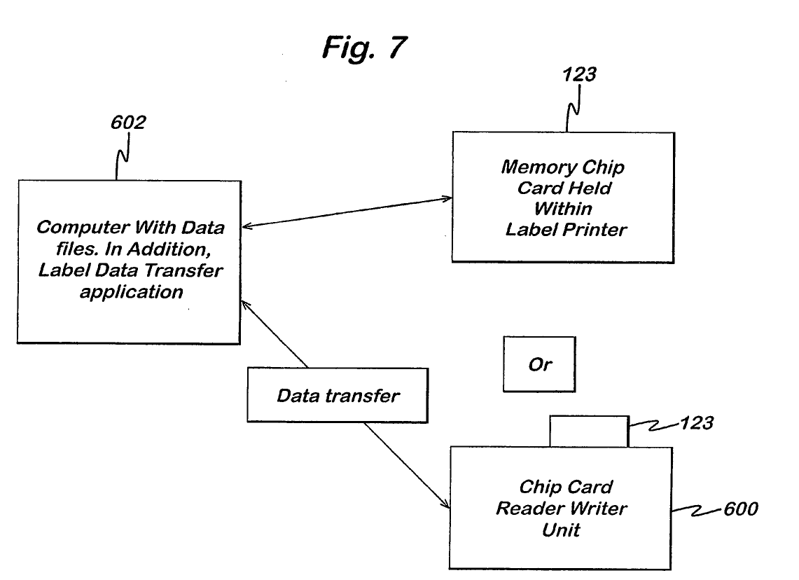

FIG. 7 shows an embodiment of the invention;

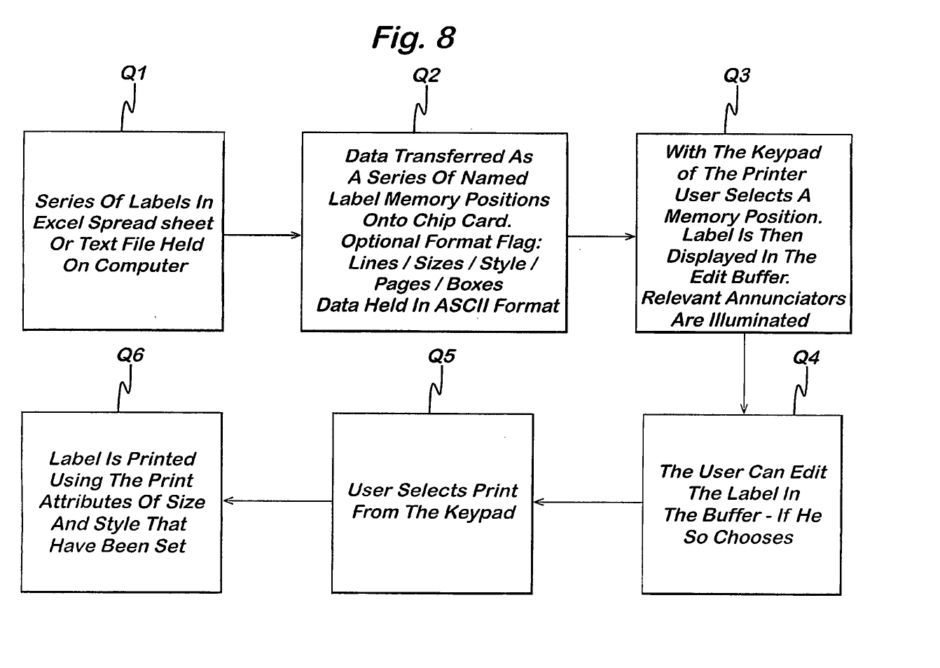

FIG. 8 shows a more detailed flow diagram of parts of the method shown in FIG. 5;

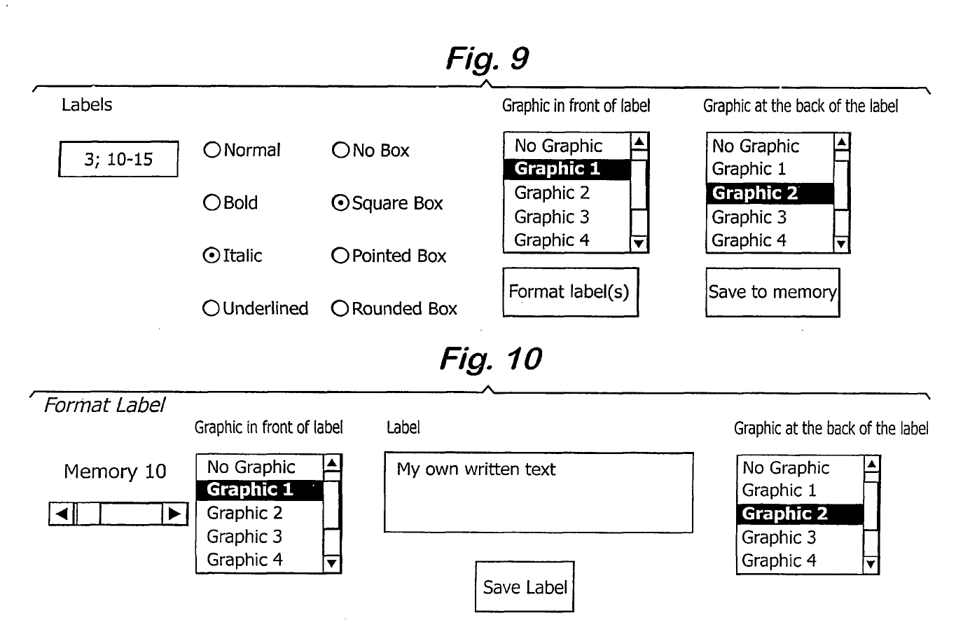

FIG. 9 illustrates the addition of a graphic element;

FIG. 10 shows a format label display; and

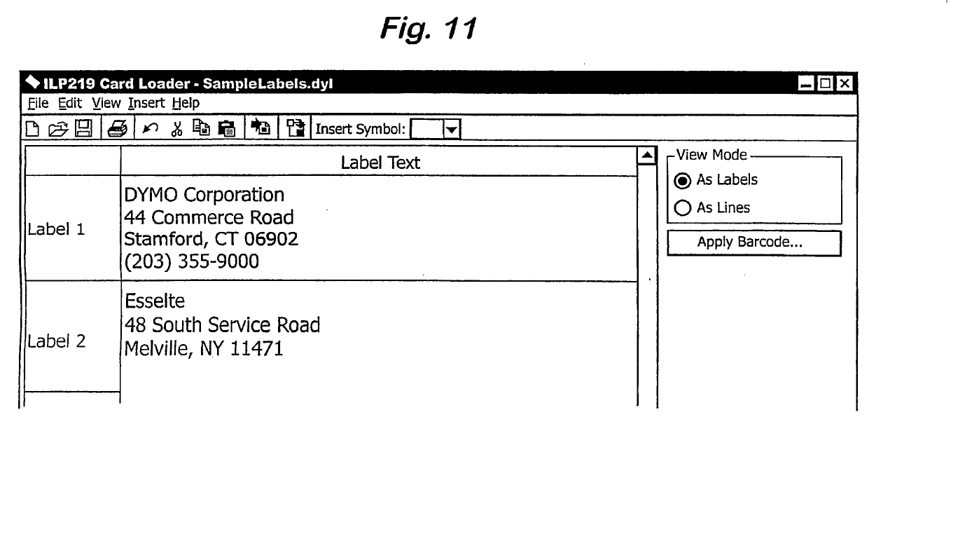

FIG. 11 shows an example of the input of data.

Reference is first made to FIG. 1, which shows a standalone printer embodying the present invention. The tape printer has a cassette receiving bay 13 which is arranged to receive cassettes as will be described in more detail with reference to FIG. 2. The cassette receiving bay 13 is covered by a lid 15, which is hinged along the line 17 at the rear of the tape printer and which can be opened from the front to reveal the cassette in the cassette receiving bay 13. It should be appreciated that in alternative embodiments of the present invention, the cassette receiving bay can be provided in alternative locations. For example, the cassette receiving bay can be provided at a different position with respect to the keyboard and display. Alternatively, the cassette receiving bay can be located on the underside of the tape printer.

The tape printer 1 has a keyboard 106, which has a plurality of character keys CK designated generally by arrow 111. The keyboard also has a plurality of function keys FK which are designated by way of example with reference numerals 110, 112, 116 and 120. Using the keyboard 106, the user is able to control the tape printer.

For example, the user is able to enter data defining a label to be printed. The label can comprise characters, numbers, symbols or the like. The function keys can control the appearance of the data and may control the label attributes, ie attributes such as boxing, underlining or the like or character attributes such as font, style, size etc. As will be described in more detail hereinafter, in preferred embodiments of the present invention, the keyboard 106 is also able to control the tape printer to generate labels from a data file contained on a memory card or the like.

A tape printer also has a display 108, which is able to display information for the user. The information displayed by the display may be the label which is to be printed. For example, as the user inputs label data, this may be displayed on the display. Alternatively, the display may provide information to the user, for example, indicating that the tape printer is processing, printing or other such information.

Reference is made to FIG. 2, which shows in plan view two cassettes arranged in the cassette receiving bay 13 of the printing device. The upper cassette 2 contains a supply of image receiving tape 4, which passes through a print zone 3 of the tape printer to the outlet 5. The image receiving tape 4 comprises an upper layer for receiving a printed image on one of its surfaces and having its other surface coated with an adhesive layer to which is secured a releasable backing layer. The cassette has a recess 6 for accommodating a platen of the printer. The platen 8 is mounted for rotation within a cage moulding 10.

The lower cassette 7 contains a thermal transfer ribbon which extends from a supply spool to a take-up spool within the cassette 7. The thermal transfer ribbon 12 extends through the print zone and overlaps with the image receiving tape 4. The cassette 7 has a recess 14 for receiving a print head 16 of the printer. The print head 16 is movable between an operative position shown in FIG. 2, in which it abuts against the platen and holds the thermal transfer ribbon 12 and image receiving tape in overlap between the print head and the platen and an inoperative position in which it is moved away from the platen to release the thermal transfer ribbon and image receiving tape. In the operative position, the platen Is rotated by the action of a stepper motor to cause image receiving tape to be driven past the print head, and the print head is controlled to print an Image on the image receiving tape by the thermal transfer of ink from the ribbon 12. The print head is a conventional thermal print head having a column of pixels, each of which can be thermally activated in accordance with the desired image to be printed.

It should be appreciated that in alternative embodiments of the present invention, a single cassette system may be used. The single cassette may have thermal transfer ribbon and image receiving tape.

In alternative embodiments of the present invention, the two cassette system may be replaced by a single cassette which houses only image receiving tape. The image receiving tape would be thermally sensitive in this embodiment of the present invention.

The tape printer 1 may be arranged so as to be capable of printing an image on different widths of image receiving tape. The tape printer may include a mechanism for detecting the width of the tape present. This may be done by making a determination of the characteristic of the cassette. Alternatively, this information may be provided to the tape printer by the user.

In yet a still further embodiment of the present invention, the tape is replaced by a supply of discrete labels provided on a backing layer. In other words, the labels are die cut and when printed are simply removed from the backing layer without requiring cutting.

It should be appreciated that embodiments of the present invention may be able to deal with continuous tape as well as die cut labels.

As shown schematically in FIG. 1, the tape printer has a slot 122 in which a memory card 123 can be slotted. The memory card can take any suitable format and may for example be a card having an integrated circuit thereon such as a smart card card or a card similar to a SIM card. Alternatively, the card 122 may be a memory card similar to a floppy disk, CD or mini disk or any other suitable data storage medium. In alternative embodiments of the present invention, the memory or integrated circuit may be incorporated in a format other than a card-like format.

In one embodiment of the present invention, the memory card or the like contains bit map images or any other suitable type of image. These images can be used as the basis of a label. In one preferred embodiments of the present invention, the image cannot be altered by the user but the user is able to add additional text. The image can be text, graphics or the like.

Reference is made to FIG. 7 which shows an arrangement embodying the present invention. In this arrangement, a docking station 600 is arranged to be connected to a PC 602 or any other suitable computer device. The docking station is arranged to receive the memory card, integrated circuit or the like and is in practice a chip card writer and optionally a reader. Information downloaded from the PC 602 is downloaded via the docking station onto the card 123. The docking station 600 simply provides a connection between the PC 602 and the memory card or the like 123. This information can take any of the forms outlined hereinafter may be labels, image data, fonts or may be programming if the card is an integrated circuit with microprocessor capacity or the like. Once the card has received the downloaded information, the card can be used with the tape printer 604 which includes a slot 608 to receive the card 123 or the like.

In one modification also shown in FIG. 7, the tape printer 604 is itself able to act as a docking station. The information form the PC is downloaded via the tape printer onto the memory card 123 or the like. In yet an alternative embodiment of the present invention, the memory card or the like is inserted into the tape printer 604 and the memory card or the like is connected to the PC via a SUB or similar connection. Data from the PC can then be downloaded directly to the memory card or the like. In the latter case, the memory card or the like may be factory fitted or may be fitted and/or changed by the user. This latter option would require a serial R48 or RJ11 jack or the like built into the tape printer.

It should be appreciated that a separate card writer which is able to write multiple copies of the same data may be advantageous where a common one or more data cards need to be given to a number of people. For examples, a garage chain may provide each of its outlets with all the retail SKU items listed.

Reference is made to FIG. 4 which schematically shows the basic circuitry for controlling the tape printer of FIGS. 1 and 2. There is a microprocessor chip 100, having a read only memory (ROM) 102, a microprocessor 101 and random access memory capacity indicated diagrammatically by RAM 14. Additional ROM and RAM capacity can be provided by separate ROM and RAM chips connected to the microprocessor. This can alternatively be provided by add-on entries or cards as discussed hereinafter. The microprocessor 101 is connected to receive data input to it from a data input device such as the keyboard 106. The microprocessor chip 100 outputs data to drive the display 108 via the display driver chip 109 and also to drive the print head and the stepper motor 18 for controlling the platen. The microprocessor chip also controls a cutting mechanism indicated diagrammatically in FIG. 4 by cutter 17 to cut the printed tape. The cutter is not shown in FIG. 2 but would be located adjacent the outlet 5. In this embodiment, the cutter is electrically operated but in alternative embodiments the present invention may be manually operated.

As can be seen from FIG. 4, there is a connection between the memory card 123 and the microprocessor chip 100. The microprocessor 100 is able to access the prestored labels, fonts, graphic images or the like stored in the memory chip 123 in a similar manner to the way in which it is able to retrieve data from the RAM 104 or ROM 102.

Reference is made to FIG. 3 which shows some examples of images which can be stored on the memory card 123. For example, the first label 300 includes the words “this belongs to”. There is then a space provided for the user to insert the desired name. The bit map may also include a graphic image which in label 300 is a flower 302. A second example of such a label 302 is also shown in FIG. 3. In this label, the words “frozen on” are stored as part of the image. The user is able to enter the date when an item was frozen.

The third example of a label, includes the words “cable number” as part of the image. The user is then able to insert the required number.

In the examples of the labels shown in FIG. 3, the labels have a fixed format. In other words, the labels have a predefined size. The characters on the labels have a predetermined font and will appear in a predetermined position in the label. In some embodiments of the invention, the user may be permitted only to add up to a maximum number of characters. In alternate embodiments of the present invention, such as the example provided by label 302, the user may only be permitted to add in a date in one of a given number of formats. Alternatively, the user may be able to select the size of the label and the image data is automatically scaled.

The memory card can store a wide range of different labels containing image information. The user may be able to add information to those labels or alternatively, the user can simply print out the label without adding any further information. Some labels may not be alterable.

Tape printers embodying the present invention may be used in a number of different environments. For example, some tape printers may be used in the home. The tape printer may be primarily used by adults or by children. The tape printer may be used in an office environment or may be used by electricians, plumbers, workers on oil rigs or the like. The same printers can therefore be used by quite different people who have different requirements.

Accordingly, a different memory card can be provided for different groups of people. For example, a memory card can be provided for children. In this case, the labels would typically be label 300 of FIG. 3 which allow children to label books, shelves etc. The labels which are designed for children may have graphic elements suitable for children. Different memory cards can be made for different age groups. For example, younger children may appreciate labels with cartoon characters whereas a memory card for older children may have graphic images more suited to that age group. Different memory cards can of course be provided for girls and boys. Memory cards with a sporting theme or the like may be provided. The memory card may contain labels featuring particular groups of cartoon characters to, for example, show various characters from a particular series of books, television series, film or the like.

Memory cards for home use by adults may include label 302, labels for labelling folders, video cassettes or CDs, or the like.

Of course, different labels may be required in an office environment to, for example, label computers, shelves, files, packages, to produce address labels, to provide notices or the like.

Electricians may require different labels for example to label cables, fuse boxes, circuits. Likewise, plumbers may have different label requirements. A different card can be produced containing sets of labels for each of these different groups of people.

This means that the same label printer may be adapted to be used by a wide range of people. This means that the user does not have to go to the trouble of designing and storing labels which would be useful to the user. Additionally, the use of memory cards means that the memory required on the label printer can be minimised, thus reducing the cost of the label printer.

It should be appreciated that in addition or alternatively, the memory cards can store different fonts and/or can store graphic images which can be imported by the user into labels.

Reference is made to FIG. 5 which shows the method by which data stored in the memory card 123 can be selected. In step T1, the chip card is installed in the printer. In step T2, the user, using the keyboard, is able to access a mode in which the user is able to search for labels stored in the memory card. For example, the user may press one or more keys to access the contents of the memory card. Alternatively, the user may be able to make this selection by the use of menus displayed on the display. The labels stored are searched. The labels may have titles which are displayed on the display. The user can move through the titles using the cursor key. Depending on the size of the display, only one or two labels titles may be displayed at a time. Alternatively, the user may be able to search for text in the labels or their titles with those labels relating to the searched for text being displayed. The user may be able to move between the labels using a cursor. As an alternative to displaying the titles of the labels, the labels themselves may be displayed. The user is able to select one of the stored labels. This can for example be done by pressing a particular key such as the enter key.

In step T3 the user can enter data into the label. As previously mentioned, the user is not able to alter some of the data or images contained in the data but may be able to enter some further information. The user can alternatively or additionally completely edit the label as required. The style settings of the label may be alterable. The user can then store the label if required. The label may be stored on the chip card or the like.

In step T4, the user selects the label to be printed. This can be after step T3 or after step T2.

Reference is now made to FIG. 8 which shows a more detailed method embodying the invention. In step Q1, a series of labels is stored in an Excel spread sheet or text file held on the PC. In step Q2, data is transferred as a series of named label memory positions onto the chip card. There are optional format flag: lines/sizes/style/pages/boxes. The data may be held in ASCII format.

In step Q3, with the keypad of the user selects a memory position. The label is then displayed in the edit buffer of the tape printer and any relevant annunciators are illuminated.

In step Q4, the user can edit the label in the buffer—if he so chooses.

In step Q5, the user selects print from the LP300 keypad.

In step Q6, the label is printed using the print attributes of size and style that have been set on the printer.

The above illustration allows only for data that contains alpha numerical data and spaces where the ASCII code will adequately describe the characters that need to be placed into the machine edit buffer. There are additional requirements which may be addressed.

Should data be needed as a bar code, then a “flag” will be provided to inform the tape printer internal software to treat the following numerals as part of a bar code. The flag would denote the bar code type.

When this data is retrieved from the chip memory it will therefore automatically be treated as a barcode entered manually from the keypad.

A further complication occurs when bar code data is mixed with text. In this case however the bar code flag should be read by the tape printer internal software, which having counted the number of characters applicable to the bar code type, then reverts to normal text.

It is very desirable to be able to store a simple graphic; such a graphic may be a logo or a line drawing of a component. The graphic should be scalable the scaling factor should be taken from the type size selection used for the label. For example the logo is stored with a 100% size and used at this size for full size font, reduced by 50% for half size font and so on. A flag in front of the graphic file (which may be in bitmap form) would inform the tape printer internal software of the presence of this form of data.

A complication is the combination of a graphic and text. However, the data flag will addresses this.

Embodiments of the invention are designed to be simple. Preferred embodiments of the present invention are arranged to operate in a wizard style where the user is prompted as required. Embodiments of the invention may be operable only via a PC, only via the tape printer or by a combination of the two. Embodiments of the present invention are arranged to operate with a full Europeans language set.

The data input used in preferred embodiments of the present invention will now be elaborated.

1 The user will be able to enter the data manually into the content slot for any memory position.

2 The user will be able to paste into the label content from the a Window's clipboard or the like.

3 The user should be able to import Into any designated range of positions a series of labels from a database in CSV format or TXT format.

4 The user will be able to use smart paste to import a simple series of labels from Excel or the like. This is described in more detail hereinafter.

In preferred embodiments of the present invention, a PC or label printer may be able to display (preferably in WYSIWYG form) the current content of the chip card when the label printer or card reader is connected to the PC or label printer.

To improve the WYSIWG appearance, the font as used by the label printer may be provided with the application. The size and style options for the font thus preferable match the fixed sizes and styles that are available with the label printer.

TABLE 1
below shows one format which may be displayed at least partially.
Thus for each memory location, the data type and label content
are shown.

| Memory | Data | |
|---|---|---|
| position | Type | Label Content |
| CM01 | Text | E.g. How Now Brown Cow |
| CM02 | B code EAN | 1342454433440 |
| | 13 | |
| CM03 | Graphic | |
| CM04 | Mixed | Widget ( B code flag) 1233434344 |
| CM05 | | |
| CM06 | | |
| CM07 | | |
| CM08 | | |
| CM09 | | |
| CM10 | | |
| CM27 | | |
| CM28 | | |
| CM29 | | |
| CM30 | | |

Alternatively, the graphics may be stored separately from the text as shown in FIG. 9. Such a system has the advantage of being memory space efficient as the bitmap image for the graphic only needs to be stored once for use on any labels. Such an example would be a company logo to prefix many labels.

In the example shown in FIG. 9, the labels can be selected and would for example be labels 3, 10, 11, 12, 13, 14 and 15. These labels would be in Italic and have a square box around them. In the example, at the beginning of the label, there would be graphic 1 and at the end, there would be graphic 2. The graphics from the dropdown menu would be fetch from a directory called \graphics. In addition, a user can add multiple graphics by selecting multiple graphics inside Windows explorer or the like and copy them into the specified directory. In addition, the user can add a single bitmap by using an import bitmap function.

The option Format Label(s) would do the actual job of formatting the selected label with the specified formats.

The Save to memory option would then program the changes onto the memory card.

Embodiments of the invention may address problems associated with multiple lines, as this is dependant on the tape size used and indicates a tape mismatch from the tape switch if the label cannot be printed.

The edit mode allows the user to change the content of a single label. The user may or may not be able to change the format, but the text inside the label can now be changed.

The scroll bar (or any way of selecting labels one by one) would let the user scroll through the labels he wants to edit.

All options that are available by the format mode illustrated in FIG. 10 can also be performed with the edit window. By the layout of the menu, the user would know how the changes are made.

The content may be saved as a single file. I.e. the content of the chip could be fully re-instated at any time in the future.

Once the user is satisfied he can select chip card update and the data will be transferred to the card, alternatively, within an independent read/write device.

If the data being transferred is to overwrite an existing label a warning message is presented in typical windows fashion with an ignore all option.

Embodiments of the present invention are able to make a distinction between the parts of label which are editable and those parts which are not. In particular, the label which is downloaded contains the field in which any text or the like entered by the user is automatically placed.

In alternative embodiments of the present invention, the memory card may be replaced by an entity containing a microprocessor or the like. The microprocessor can be contained in any suitable carrier. The integrated circuit may be carried in a card or contained in a device which can be plugged into the tape printer. The microprocessor can be arranged to augment the functionality provided by the microprocessor 100 shown in FIG. 4 or may be arranged to take over the control of the tape printer. The microprocessor would generally include a microprocessor part and additionally some memory capacity. The memory capacity can take any suitable format and may be ROM and/or RAM memory or any other suitable type of memory. The memory may contain programming to control the operation of the microprocessor. The programming contained on the microprocessors can control the tape printer to perform functions which the tape printer is not able to perform without that programming. For example, the tape printer can be provided with a basic microprocessor and functionalities with more sophisticated functions controlled by the plug in microprocessors. For example, the microprocessor can control the tape printer to carry out more sophisticated processing of data.

The tape printer may be arranged to receive the microprocessor or the like as well as a memory card as described.

The memory can be a flash memory of the like.

In one embodiment of the present invention, a memory card may be provided which stores a data base or the labels which are generated as discussed hereinafter. A microprocessor can be provided on a card, which may be the same or different to the card having the data base or the like to deal with that data base or alternatively, the microprocessor of the tape printer may be able to deal with that information. From this data base, it is possible to automatically generate a number of labels. These labels can originate from a data file, a clipboard function or any other application. The label data can, for example, consist of a list of names, lists of addresses, lists of names and addresses, lists of articles to be labelled or the like. The data file can be a plain ASCII text file or any other suitable file.

Consider the following examples: The data contained in the data file may be printed such that the data to be printed on each label is contained in a single line of the data file.

Considering the following example of a data file:
Pencils, US$100
Pens, US$0.50 each
Erasers, US$1.00.

This would generate three labels, the first label would be “Pencils, US$100”. The second label would be “Pens, US$0.50 each”. The third label would be “Erasers, US$1.00”. In one modification to this embodiment, the microprocessor software can be arranged to determine if any of the lines contain a comma. Where a comma is located, it can be determined that a new line is required. Thus, the labels outlined above would each have two lines, each new line beginning after the comma. Label 1 would thus be:
Pencils,
US$100.

Label 2 would be:
Pens,
US$0.50 each.

Label 3 would be:
Erasers,
US$1.00.

In some embodiments of the present invention, the comma can be omitted from the two line labels.

In one further modification of this embodiment, lines of the label which are to contain commas are themselves in quoted text. For example consider the following list:
Dymo Corporation, 44 Commerce Road, “Stamford, Conn. 06902”
Esselte N V, Sint Niklaas, “9100, Belgium”.

In embodiments of the present invention, this would give rise to the following two labels:

Label 1

Dymo Corporation
44 Commerce Road,
Stamford, Conn. 06902.

The second label, Label 2, would be:
Esselte N V,
Sint Niklaas,
9100, Belgium.

In summary, the data can be presented in a list, with each new line representing a new label. Within each label, a new line is started every time a comma is encountered. If a single line on the label is to contain a comma, then part of the text is included in inverted commas or the like. The inverted commas are not printed, although the commas are. It should be appreciated that any other indicators other than commas or inverted commas can be used in embodiments of the present invention.

Reference will now be made to a second type of data file from which labels can be automatically generated. In this, the data for each label appears on subsequent lines separated by a carriage return, line feed or both. Subsequent labels within the data are separated by blank lines. Firstly, the data in the document is examined to see if there are any blank lines in the data. If so, the text is assumed to consist of a plurality of labels, each of which is separated by the blank lines. Consider the following examples of a data file:
Pencils
US$1.00
   (Blank line)
Pens
US$0.50 each.

The software is changed to take the presence of a blank line into account and provide labels 1 an 2 as outlined in the respective previous examples. Consider the following example:
Tom Smith
Bob Jones
Mike Smith.

In this situation, each line becomes its own label, in other words, three labels are provided, one with each of the three names. It is assumed that this is the case if it is detected that there are no blank lines within the data. The data in this latter case may be generated by copying information from a column of a spreadsheet, a word processing document, or other data source.

Embodiments of the present invention may be able to support the generation of labels from any of the data files mentioned previously. FIG. 6 shows a flow chart illustrating how this may be achieved in practice. The data file is considered and in step S1 a determination is made as to whether or not there are any blank lines between the data and the data file. By “blank lines” it is meant an empty line or the like. If it is determined that there are empty lines, then labels are generated as already outlined. Each label consists of the data between two blank lines. This is carried out in step S2.

In step S3, which is the next step if there are no blank lines, a determination is made as to whether or not there are any commas in each line of data. If no commas are detected, then step S4 is the next step. In step S4, each line represents a single line label, which are then generated. This is as previously outlined. If it is determined in step S3 that there are commas within each line then the next step is S5. Each line again represents a single label but a determination as to the number of lines of the label is made from the determination of the number of commas. Commas in inverted commas are of course ignored, as previously described. In alternative embodiments of the present invention, only one or some of the various types of data file can be processed.

The data file can take any suitable format. For example, the data may be a word processing document, may be in a spreadsheet form, for example an Excel spreadsheet or the like.

It should be appreciated that embodiments of the present invention may use other indicators other than the examples of blank spaces to determine the commencement of a new label. Any suitable marker can alternatively be used.

In some embodiments of the present invention, the printer may incorporate a time stamp. The time stamp can be used to insert the date and/or time into labels.

The interface between the memory card, or microprocessor and the microprocessor of the tape printer is via a serial interface. In the case of a card or the like containing a microprocessor, a parallel interface may be provided.

One application of an embodiment of the invention will now be described in detail.

Embodiments of the invention can solve the the following problems and needs:
No more typing errors for the more PC experienced users that can prepare the label files on their PC instead of having to type everything on the ABC and/or small keyboard and can for exmaple use well known word and data processcing packages such as MICROSOFT (Trade mark) WORD and EXCELusing excel);
A link can be made with information coming from a CAD system (example ASCII file coming from the EPLAN or other electrical software package);
Logos and special symbols can also be stored on the memorycard to help the customer to customise their job; and
The installer, who needs to label things, does need to bring in his label printer into the office before starting a new job (for example to download the information into the printer) and wait until the information is downloaded. He now just gets a memory card together with his cables, components, tapes etc.

In the software to be used on a PC, the end-user (in the office or workplace) can input all data that is needed to be printed. FIG. 1 shows one example of this. At the same time the user can also import any ASCII data or TXT file formatted data.

Once all data is entered in the software on the PC, the data is given a name so the card gets identified. The information is then downloaded into the card which needs to be in the label printer as discussed above. In this embodiment, there is no need for a separate card writer. It should be appreciated that the label printer need not be the actual label printer which is used for printing the labels.

When the label set is input completely on the PC, the user can download the label set it to a memory card in a label printer attached to the PC. The label set can be downloaded as many times as required to different memory cards allowing several people to use the same label information on their individual label printers.

If a Card identity has not been sent, a prompt message will appear. If the label printer is not connected properly, an error message will appear. A confirmation dialog will appear advising that the labels and graphics currently stored in the memory card of the label printer will be replaced with the new label set. Once the labels and graphics have been downloaded to the card, the labels and graphics in your label are now available to print on the label printer.

Thus the label printer is not only a simple printer it is also a card-writer and card-reader. In some embodiments of the invention, a separate device is not required in addition to the PC as the label printer handles the whole process. The information that is downloaded to the label printer has a special format (strings) that is linked to the internal language.

Using the memory card in the label printer may also give some additional options piloted through the printer:
On a label “graphics” from the memory card (example: a company logo) and standard inputted text (through the keyboard) can be mixed. The graphics can be added at the beginning and/or at the end of the label.
Only certain labels from a list can be printed. For example, there is a group (or file) with 20 labels. It possible for example to print only from label 7 to label 12. It is also possible to print out a single label.
Of course all of the labels can be printed from the memory card.

In one embodiment of the invention, the memory card does not include any format or label information. The exception to this is where text it to be printed in barcode format where the barcode format is included in the memory card.

The label settings and/or character attributes are set in the label printer so the text contained in the memory card is printed with the settings. The label settings and/or character attributes are used for an individual label or for all of the selected labels contained in the memory card.

In alternative embodiments, label setttings and/or character attributes may be stored on the card. Alternatively or additionally, one or more other settings could be stored on the memory card (for example: size of the label, colour of tape, ink ribbon information, temperature settings, or the like). Accordingly, when a user selects a label to be printed, the size of the label, the colour of the tape, the type of the ink ribbon and/or the temperature setting for the print head are already set. If the label printer has automatic cassette, tape or ink ribbon detection which provides the required information or if the user is required to input this information, the relevant characteristic is compared with the desired characteristic and the user is informed if there is a discrepancy. This can be done by displaying a message on the display and/or having an audible sound or message. The user can in some embodiments of the invention override the discrepancy so the label is printed using the tape and ink ribbon present. As far as the print head control is concerned, the print head can be controlled in accordance with the provided information. In some embodiments of the invention, the label printer may be arranged so that it is only possible to print the label with the right ink ribbon, tape etc.

It should be appreciated that in some embodiments of the present invention, there may not be any automatic detection or entry of this information so the nature of the ink ribbon and/or the tape may be unknown. In this case, a message may be displayed on the display which advises the user as to the tape and/or ink ribbon requirements.

In one embodiment of the invention, the user when inputting the label can define the type of label which is to be used, taking into account the environmental conditions. For example, humid, hot or cold environments may require different labels or different labels may be suited to specific environments. Some labels may be suitable for a range of environments but in practice may be expensive. Accordingly the user may only wish to use it in environments where cheaper labels would not be effective.

The surface to which the label is to be stuck may also determine the type of label to be used. Different degrees of adhesion may be required for different surfaces and/or for different label applications. The user can therefore define the label which should be used depending on what the label is to be applied.

As mentioned, the colour of the label and/or the image applied (by for example an ink ribbon) can also be defined. It should be appreciated that in some environments colour coding may be used and it is therefore important to make sure that the correct colour is used.

In one embodiment of the invention, the card or the like may include a plurality of formats. The data for a given label may identify one of these formats so that the data is printed with the correct format. Alternatively when a user prints out the label, the user may select one of the formats from the card. This is useful where the same label is applied to a plurality of different items which may differ in size or the like. The format may include character attributes, layout attributes as well as information defining where different parts of the data are to be provided.

The user when entering the data into the card may also specify the size of the label to be used with the data or where the label is to be printed more than once, the sizes of the label.

It should be appreciated that in some embodiments of the invention, the label data may specify the colour of the tape, the colour of the ink ribbon, the type of the label, the format to be used and/or the size of the label. Where a given set of data is to be printed more than once, different tape colour, ink ribbon colour, type of label, format and/or size may be associated with the different labels containing the same data.

1. A label printer comprising:
a receiving means which is arranged to receive a removable memory, wherein the removable memory comprises information for one or more labels, and wherein the information for one or more labels comprises (i) data to be printed by the label printer and (ii) information relating to the one or more labels; and
a means for retrieving the information for one or more labels from the removable memory and communicating the information for one or more labels from the removable memory to the label printer.

2. The printer of claim 1, wherein information relating to the one or more labels comprises at least one of label color, ink ribbon color, label material, label size, or label format.

3. The printer of claim 2, wherein the material for the one or more labels is selected based upon the environment in which the one or more labels is to be used.

4. The printer of claim 1, wherein the removable memory comprises one or more label formats.

5. The printer of claim 4, wherein the removable memory comprises a memory card, wherein the one or more label formats are provided on the memory card, and wherein the memory card identifies the one or more label formats with which the data is to be printed.

6. The printer of claim 1, wherein at least one set of label data is arranged to be printed a plurality of times and said at least one set of label data comprises a plurality of information for at least two different labels to be printed with said at least one set of label data.

7. The printer of claim 1, wherein the printer further comprises a means for comparing the information for one or more labels with at least one piece of information automatically detected by the printer or input by the user.

8. The printer of claim 7, wherein the label printer is arranged to indicate to the user that there is a discrepancy between the information for one or more labels and the at least one piece of information automatically detected by the printer or input by the user.

9. The printer of claim 8, wherein the printer is prevented from printing the label if there is a discrepancy between the information for one or more labels and the at least one piece of information automatically detected by the printer or input by the user.

10. The printer of claim 1, wherein at least one of the labels is such that a user of the printer is able to add information to the label.

11. The printer of claim 1, wherein at least one of the labels is at least partially unalterable.

12. The printer of claim 1, wherein when a label is partially unalterable, input provided by the user is placed by the label printer in a predetermined field.

13. The printer of claim 1, wherein at least one label has a predetermined size.

14. The printer of claim 1, wherein the size of at least one label is selectable by the user or controlled through input data.

15. The printer of claim 1, wherein the removable memory is arranged to store at least one image.

16. The printer of claim 15, wherein the at least one image is a bit map.

17. The printer of claim 1, wherein the removable memory stores font data.

18. The printer of claim 1, wherein the removable memory comprises a memory card, a smart card, a floppy disk, a CD, a mini disk, or an integrated circuit card.

19. The printer of claim 1, wherein a removable processor is provided with the removable memory.

20. The printer of claim 19, wherein the removable processor is arranged to at least partially control the printer.

21. The printer of claim 1, wherein the printer is arranged to be connected to a PC.

22. The printer of claim 1, wherein the printer is arranged to be connected to a PC.

23. The printer of claim 22, wherein the printer is arranged to write to the removable memory when connected to the PC.
